(19) United States
(12) Patent Application Publication
(10) Pub. No.: US 2009/0164432 A1
(43) Pub. Date: Jun. 25, 2009

(54) SYSTEM AND METHOD FOR GENERATING A PRODUCT REPORT

(75) Inventors: Chi-Chih Wang, Tu-Cheng (TW); Yong-Hua Song, Shenzhen City (CN); Rui-Jun Wang, Shenzhen City (CN); Shan-Sheng Wu, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO.,LTD., Shenzhen City (CN); HON HAI PRECISION INDUSTRY CO., LTD., Tu-Cheng (TW)

(21) Appl. No.: 12/332,352

(22) Filed: Dec. 11, 2008

(30) Foreign Application Priority Data
Dec. 21, 2007 (CN) 200710203326.4

(51) Int. Cl. G06F 7/06; G06F 17/30

(52) U.S. Cl. 707/3; 707/E17.014

(57) ABSTRACT

A method for generating a product report is provided. The method set columns for different product reports and attributes of each of the columns. A control object for each of the columns is generated according to the attributes of each of the columns. The method further searches product data of the columns stored in a data storage system according to the attributes of the columns, and generates a product report by integrating all the control objects of the columns according to the searched product data.

### BACKGROUND

1. Technical Field

Embodiments of the present disclosure relate to report management systems and methods, and more particularly to a system and method for generating a product report.

2. Description of Related Art

Various product information systems are employed in manufacturing plants to maintain product quality. Product information may be held or stored in different information systems located in various departments, such as production departments, sales departments, and warehouses of a factory.

Because product information is kept in different locations, it is necessary for users to gather product information from various departments to generate a product report. However, there may be a need to adjust relationships between columns of the product report or to adjust attributes of the columns, but is difficult to do so as some columns of the product report are in fixed form.

Therefore, an effective system and method for generating a product report is desired to overcome the above-described shortcomings.

### BRIEF DESCRIPTION OF THE DRAWINGS

FIG. 1 is a block diagram of one embodiment of a system for generating a product report.

FIG. 2 is a block diagram of one embodiment of a computer comprising function modules.

FIG. 3 is a flowchart of one embodiment of a method for generating a product report.

FIG. 4 shows one embodiment of a list of attributes of columns of a product report.

### DETAILED DESCRIPTION OF CERTAIN INVENTIVE EMBODIMENTS

All of the processes described below may be embodied in, and fully automated via, functional codes modules executed by one or more general purpose processors. The codes modules may be stored in any type of computer-readable medium or other computer storage device. Some or all of the methods may alternatively be embodied in specialized computer hardware or communication apparatus.

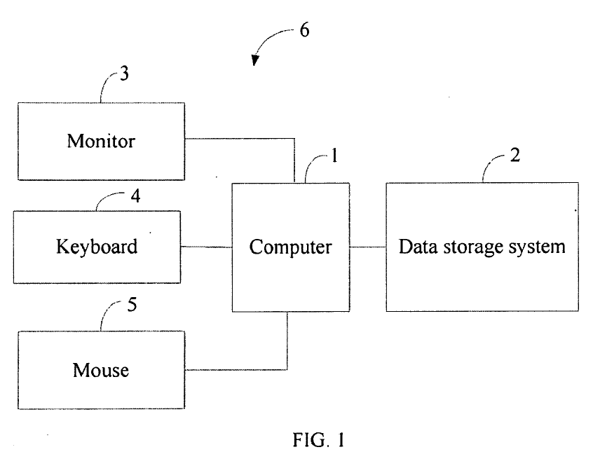

FIG. 1 is a block diagram of one embodiment of a system 6 for generating a product report. In one embodiment, the system 6 includes a computer 1, and a data storage system 2 connected to the computer 1. The data storage system 2 stores product data for generating different product reports. In one embodiment, the product data may include manufacturing plants, part names, and part numbers of different products. The computer 1 connects with a keyboard 3, a mouse 4, and a monitor 5, all of which are used as input and output devices.

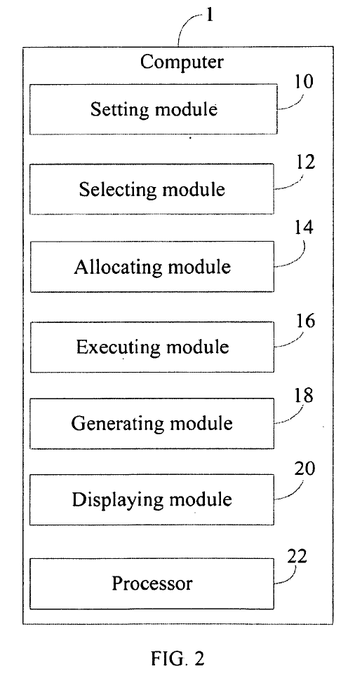

FIG. 2 is a block diagram of one embodiment of the computer 1 comprising function modules. In one embodiment, the computer 1 may include a setting module 10, a selecting module 12, an allocating module 14, an executing module 16, a generating module 18, and a displaying module 20. It may be understood that one or more specialized or general purpose processors 22 may be used to execute the function modules 10, 12, 14, 16, 18, and 20. These function modules may be used to perform certain functions for generating the product reports.

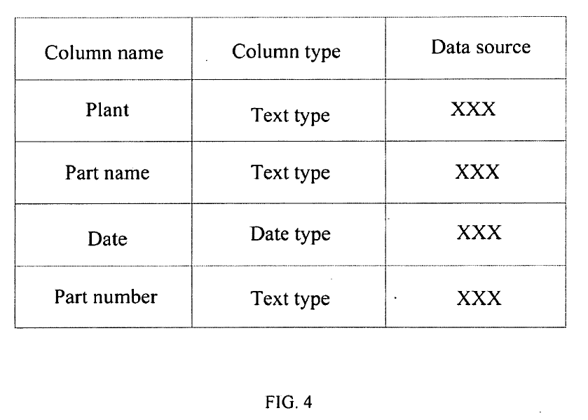

The setting module 10 is configured for setting a plurality of columns for different product reports and attributes of each of the columns. The attributes of the columns may include a column name, a column type, and a data source. The column type includes a text type, a date type, and so on. As shown in FIG. 4, the columns may include a plant column, a part number column, a part name column, a date column of a product although the disclosure is not limited thereto. In the illustrated embodiment, the column types of the plant column, the part number, and the part name are the text type. The column type of the date column is the date type.

The selecting module 12 is configured for selecting one or more columns for a product report to be generated from the set columns for generating a product report according to user's requirements. In one embodiment, if the plant column and the part number column are requested to generate the product report, the selecting module 12 then selects the plant column and the part number column from the set columns.

The allocating module 14 is configured for allocating a serial number for each of the selected columns according to relationships between the selected columns defined by a user. For example, if the user defines that the part number column is subordinate to the plant column, the allocating module 14 allocates a serial number “1” to the plant column, and allocates a serial number “2” to the part number column.

The executing module 16 is configured for generating a control object for each of the selected columns in sequence according to sequence of the allocated serial numbers. The control object is defined according to the column type of each of the selected columns, and may be a text control box, or a date control box. For example, assuming that the plant column is allocated the serial number “1,” and the part number column is allocated the serial number “2,” then the control object for the plant column is generated before generating another control object for the part number column. As explained above in FIG. 4, the column types of the plant column and the part number are the text type, therefore the executing module 16 generates a text control box for the plant column, and then generates another text control box for the part number column.

The generating module 18 is configured for searching product data of the selected columns in the data storage system 2 according to the data sources and the relationships between the selected columns, and for generating the product report by integrating all the control objects of the selected columns according to the searched product data. For example, a plant “A” manufactures a particular product having a part number “B,” the generating module 18 searches product data of the plant “A” in the data source of the plant column and searches product data of the part number “B” in the data source of the part number column. Because the part number column is subordinate to the plant column, the generating module 18 searches the product data of the part number “B” which is subordinate to the plant “A.”

The displaying module 20 is configured for displaying the generated product report on the monitor 3.

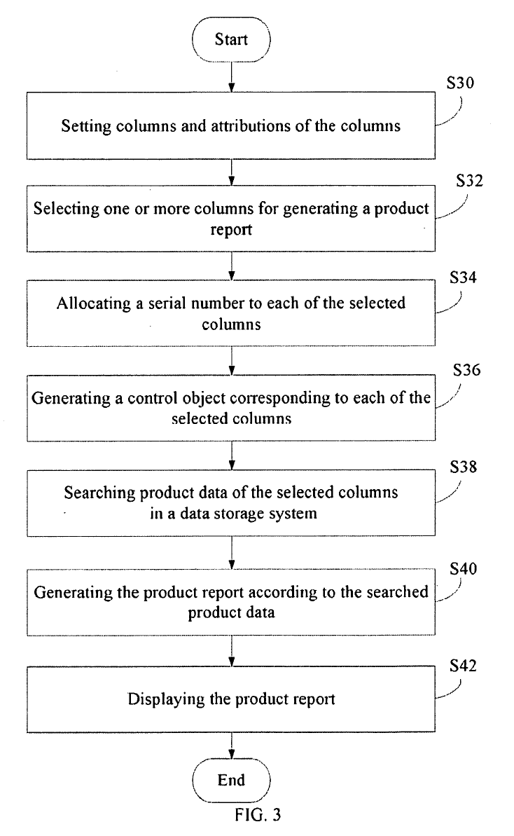

FIG. 3 is a flowchart of one embodiment of a method for generating a product report. Depending on the embodiment, additional blocks may be added, others removed, and the ordering of the blocks may be changed.

In block S30, the setting module 10 sets a plurality of columns for different products report and attributes of each of the columns. The attributes of each of the columns may include a column name, a column type, and a data source.

In block S32, in order to generate a report, the selecting module 12 selects one or more columns for a product report to be generated from the set columns.

In block S34, when a user defines relationships between the selected columns, the allocating module 14 allocates a serial number for each of the selected columns according to the relationships.

In block S36, the executing module 16 sequentially generates a control object for each of the selected columns according to the attributes of each of the selected columns in the same sequence as the serial numbers. In one embodiment, the plant column is allocated a serial number “1”, and the part number column is allocated a serial number “2”, so the control object for the plant column is generated before generating another control object for the part number column.

In block S38, the generating module 18 searches product data of the selected columns in the data storage system 2 according to the data sources of the selected columns and the relationships between the selected columns.

In block S40, the generating module 18 generates the product report by integrating all the control objects of the selected columns according to the searched data.

In block S42, the displaying module 20 displays the generated product report on the monitor 3.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for generating a product report implemented by a computer having a data storage system, the computing system comprising:
a setting module configured for setting a plurality of columns for different product reports and attributes of each of the columns, the attributes comprising a column type and a data source;
a selecting module configured for selecting one or more columns for a product report to be generated from the set columns;
an allocating module configured for allocating a serial number for each of the selected columns according to relationships between the selected columns;
an executing module configured for generating a control object for each of the selected columns in the sequence of the allocated serial number according to the column type of each of the selected columns;
a generating module configured for searching product data of the selected columns in the data storage system according to the data source and the relationships, and for generating the product report by integrating all the control objects of the selected columns according to the searched product data; and
at least one processor that executes the setting module, the selecting module, the allocating module, the executing module, and the generating module.

2. The system of claim 1, further comprising:
a displaying module configured for displaying the generated product report on a monitor of the computer.

3. The system of claim 1, wherein the attributes of the each of the columns further comprises a column name.

4. The system of claim 1, wherein the control object is defined according to the column type of each of the selected columns.

5. The system of claim 1, wherein each of the control objects is selected from the group consisting of a text control box and a date control box.

6. A computer-implemented method for generating a report implemented by a computer having a data storage system, the method comprising:
setting a plurality of columns for different product reports and attributes of each of the columns, wherein the attributes comprises a column type and a data source;
selecting one or more columns for a product report to be generated from the set columns;
allocating a serial number for each of the selected columns according to relationships between the selected columns;
generating a control object for each of the selected columns in the sequence of the allocated serial number according to the column type of each of the selected columns;
searching product data of the selected columns in the data storage system according to the data source and the relationships; and
generating the product report by integrating all the control objects of the selected columns according to the searched product data.

7. The method of claim 6, further comprising:
displaying the generated report on a monitor of the computer.

8. The method of claim 6, wherein the attributes of the each of the columns further comprises a column name.

9. The method of claim 6, wherein the control object is defined according to the column type of each of the selected columns.

10. The method of claim 6, wherein each of the control objects is selected from the group consisting of a text control box and a date control box.

11. A computer-readable medium having stored therein instructions that, when executed by a computer, cause the computer to perform a method for generating a product report, the method comprising:
setting columns for different product reports and attributes of each of the columns, wherein the attributes comprises a column type and a data source;
selecting one or more columns for a product report to be generated from the set columns;
allocating a serial number for each of the selected columns according to relationships between the selected columns;
generating a control object for each of the selected columns in the sequence of the allocated serial number according to the column type of each of the selected columns;
searching product data of the selected columns in a data storage system according to the data source and the relationships; and
generating the product report by integrating all the control objects of the selected columns according to the searched product data.

12. The medium of claim 11, wherein the method further comprises:
displaying the generated report on a monitor of the computer.

13. The medium of claim 11, wherein the attributes of the each of the columns further comprise a column name.

14. The medium of claim 11, wherein the control object is defined according to the column type of each of the selected columns.

15. The medium of claim 11, wherein each of the control objects is selected from the group consisting of a text control box and a date control box.
